(19) United States
(12) Patent Application Publication
(10) Pub. No.: US 2003/0030226 A1
(43) Pub. Date: Feb. 13, 2003

(54) Elastomeric sealing element for gas compressor valve

(76) Inventor: Kevin Patrick Durham, Sugar Land, TX (US)

Correspondence Address: Carol M. Nielsen, GARDERE WYNNE SEWELL LLP, Patent Section (H), 1601 Elm Street, Suite 3000, Dallas, TX, 75201, US

(21) Appl. No.: 10/194,576

(22) Filed: Jul. 12, 2002

Related U.S. Application Data
(60) Provisional application No. 60/305,336, filed on Jul. 13, 2001.

(51) Int. Cl. F16J 15/16

(52) U.S. Cl. 277/500

(57) ABSTRACT

This invention relates to the use of elastomers with the sealing element of reciprocating gas compressor valves to increase the reliability of the gas tight seal within the reciprocating gas compressor valve and to increase the useful life of reciprocating gas compressor valve. The elastomeric material is either used as a coating layer on the sealing element of the reciprocating gas compressor valve, or as the entire sealing element. The elastomeric material acts as a cushion to reduce the wear on the sealing element, provides a superior gas tight seal, and is more tolerant of entrained dirt or liquids in the gas stream thereby increasing the operable life of the reciprocating gas compressor valve. Reducing the mean time between reciprocating gas compressor valve failures results in longer reciprocating gas compressor run times for the user, increased revenue generation for the user and safer operation of said equipment.

### CROSS REFERENCE TO RELATED APPLICATION

The present application claims priority under Title 35, United States Code §119 of U.S. Provisional Application Serial No. 60/305,336, filed Jul. 13, 2001.

### TECHNICAL FIELD

This invention relates to improved sealing and operational reliability of reciprocating gas compressor valves. More specifically, this invention is directed to the use of elastomeric material in connection with a sealing element of a reciprocating gas compressor valve to produce a reliable, durable seal.

### BACKGROUND OF THE INVENTION

Reciprocating gas compressors are equipped with valves that open and close to intake and expel gases. Often such valves alternate open and close with each revolution of the compressor crankshaft and there are a very large number of suction and discharge events per minute. As a consequence, the valve must be designed to tolerate a high level of repetitive stress. The sealing element of the valve establishes a seal between it and the opposing, fixed seating surface. Without proper sealing, hot discharged gas leaks back into the cylinder and temperatures escalate from recompression of the gas. Hence, the overall throughput, reliability, efficiency and revenue generating ability of the reciprocating gas compressor are diminished.

While the valves in a reciprocating gas compressor are of various types and forms, each valve has a seating surface, a moving sealing element, a stop plate and mechanism to force the valve elements to close before the compressor piston reaches top or bottom dead center. The sealing element is pressed against the corresponding seating surface to close the valve by a combination of spring forces and differential pressures. The differential pressures are considerably larger in magnitude than the spring forces. An example of a typical reciprocating gas compressor valve is described in commonly assigned U.S. Pat. No. 5,511,583 to Bassett.

During the operation of the valve, the seating surface and the sealing element may be damaged by impact from liquids or solids entrained in the gas stream. Furthermore, operating conditions may vary in such a way that the sealing element strikes the seating surface at velocities higher than design tolerances of the sealing element or the seating surface. In other words, the forces generated cannot be tolerated by the sealing element. In such cases, the force of impact may cause fractures in the sealing element, accelerated wear in the sealing element and/or seating surface, and recession of the sealing areas of the sealing element. The recession phenomenon is particularly evident in sealing elements made of thermoplastic or metallic materials. Many traditional materials currently used do not have the ability to dissipate the energy resulting from high impact velocities, or entrained dirt and liquids and this may lead to premature failure of the ability of the reciprocating gas compressor valve to provide a gas tight seal.

When the sealing element or the seating surface is damaged and the ability to form a gas tight seal is lost, the valve or component elements must be replaced or refurbished. Additionally, in many cases such valve failures may be catastrophic in nature and result in damage to other parts of the reciprocating gas compressor or downstream equipment. Therefore, the longevity of the seal between the sealing element and the seating surface results in an increase in the useful life of the reciprocating gas compressor valve as measured by the mean time between failures of the reciprocating gas compressor valve.

The sealing elements of reciprocating gas compressor valves have historically been made of metal. However, rigid thermoplastic materials were introduced in the early 1970's. Both materials are used today. These stiff, non-elastomeric materials require a fine machine finish and are often lapped in order to further reduce surface defects. The contact surface of the seat may be flat or shaped in a manner that mimics the surface contours of the moving sealing element.

When using a metal, thermoplastic material, or other rigid material as the sealing element, for the seal to be fully gas tight, the surfaces of the sealing element and particularly the sealing surface must be smooth and free from defects. In any machining operation, the cost and time required for manufacture are directly related and proportional to the surface finish required. Tighter tolerances require machine tools that are more precise and expensive. If there are defects in the sealing of a valve, gas will leak through the valve, component temperatures will elevate and the reciprocating gas compressor will operate in a highly inefficient manner. Furthermore, once the sealing integrity of the compressor valve has been compromised, the reciprocating gas compressor must be shutdown for the repair or replacement of the reciprocating gas compressor valves.

Rigid thermoplastic materials are often filled or blended with glass fibers and other materials in order to create the properties necessary for the service conditions. The method of molding and mold design can be critical for properly aligning fibers. Furthermore, proper alignment of fibers is critical to strength and/or mechanical properties of the sealing element. Moreover, poor mold flow characteristics weaken the sealing element and make it susceptible to failure from stress raisers in the material.

Injection molding of thermoplastics requires special mold and competent mold design in order to alleviate the problems of rigid thermoplastic materials. Thermoplastic materials create wear in a mold as the plastic and abrasive fillers (e.g., glass) flow through the internal passages. Repairing or replacing a mold adds to the overall expense of the manufacturing operation.

Metal parts require rather stringent dimensional and surface finish tolerances. Machine tools capable of generating such tolerances are generally more expensive and more time is always needed to create the sealing element. This is true for thermoplastic parts as well. For example, metal sealing elements require lapping and must be put on a separate machine to be lapped to the required surface finish. Time and expense are added to the process.

Quality control of rigid components is a key step in the successful operation of the parts. Dimensional conformance must be monitored and inspected regularly to ensure a consistent product. Thermoplastic parts are susceptible to water absorption, causing swelling and dimensional changes even during storage. The changes are often severe enough to render the parts unusable. Metal parts can rust and pitting can occur that destroys the fine finishes. Parts that are mishandled or allowed to collide with other hard objects during shipment can make them unusable. This adds to the warranty loss of the supplier.

There are an infinite number of operating conditions that exist. The variables include temperature, speed, impact or shock damage during opening and closing, pressure, gas constituents, and the amount of entrained dirt and or liquids in the gas. The service life of a valve is typically inversely proportional to the amount of debris (liquid or solid) in the gas stream. As particles strike the fine surfaces of the sealing element, damage to the valve degrades its ability to establish a gas tight seal. Recovery of the gas tight seal is not possible unless the sealing element of the valve is replaced or refurbished.

Due to disruptions in service conditions and due to the nature of the motion of the sealing elements during operation, the brittle metals and thermoplastics may suffer chipping of the edges. Chipped surfaces often lead to fractures and subsequent failure of the valve whereby the sealing elements fracture into one or more parts. Total replacement of the valve is then necessary.

A need exists, therefore, for a sealing element that efficiently seals a reciprocating gas compressor valve for the purpose of improving reliability and durability.

### SUMMARY OF THE INVENTION

The present invention is a reciprocating gas compressor valve comprising a sealing element made of and having at least one layer of elastomeric material. The sealing element may have a single layer or multiple layers of elastomeric material or be entirely elastomeric material.

The novel use of elastomeric materials in reciprocating gas compressor valves provides the following benefits. First, the inherent property of elastomers to flex and conform to irregular or damaged surfaces produces a gas tight seal over a variety of damaged or undamaged surfaces. In short, the use of elastomers provides greater confidence that a gas tight seal is established even when the sealing surfaces are not smooth or in perfect condition. Second, the use of elastomeric material eliminates the process of lapping the sealing surfaces. Most valves and valve designs make use of lapping to create or restore sealing surfaces. Lapping produces the fine finishes necessary to establish a gas tight or near gas tight seal in the current state of the art. Surface finishes possible by present day machining technology can easily generate a surface finish that can be sealed with an elastomer part. A great deal of manual labor and additional production costs can be eliminated. Third, since elastomeric material can be attached to nearly any form or geometry, sealing element shapes that are more aerodynamic than the current state of the art are now possible. Designing more aerodynamics shapes lowers pressure drops through the valve. Fourth, elastomers can flex and conform, and machining tolerances can be relaxed. This is a direct cost saving to the production of the parts. Current compressor valve technology requires rather tight machining tolerance in order to assure a gas tight seal. Fifth, elastomeric material may be designed to have a density less than the density of the rigid substrate of the sealing element. Therefore the parts coated are less massive and less massive parts make for less destructive collisions when the valve element makes contact with the valve seat at the time of closing. Simply having less mass means that impact energies are reduced and the parts will suffer even less damage during the closing event. Sixth, elastomeric sealing elements are relatively easy to make and cost competitive. Tight tolerances are less important. Therefore, complicated shapes can be made and the elastomer can be applied as a final step. Seventh, since elastomeric materials may be formulated in a nearly infinite number of ways, those skilled in the art have nearly as many possible solutions to a particular compressor valve performance problem. Eighth, elastomeric materials are a source for improved plant efficiency and a source for increase revenue generating capability for users of reciprocating gas compressors. Uninterrupted operation for longer periods of time means more revenues and lower maintenance cost for the end user. Ninth, elastomeric material dissipates impact energies better during the closing events. Currently used non-resilient materials lack this property and the ability of the valve to form a gas tight seal for extended periods of time diminishes. Finally, because elastomeric materials can better tolerate the impact energy at the closing event of gas compression, it will be possible to permit valve elements to operate with far more travel than current technology will allow. The capability of being able to open the valve more fully will further reduce pressure drops (losses through the valve) and improve operating efficiencies.

Sealing elements come in a variety of shapes. There are many reasons for the different shapes, but primarily the goal is to 1) improve the aerodynamics as the gas passes over and around the element and through the valve; 2) improve the strength of the part to make it less susceptible to the rigors and upsets of the operating conditions; and 3) create a real or perceived differentiation between manufacturers in order to improve sales. Furthermore, in spite of the variety of shapes, all current valve designs suffer from damage by entrained dirt and liquids in the gas stream and the accumulated wear of a large number of opening and closing events. The present invention makes use of the inherent properties of elastomeric materials to overcome this weakness of conventional materials.

The sealing element of the subject invention may be useful in any reciprocating gas compressor where gases are compressed at virtually any pressure and temperature. The reciprocating gas compressor valve may be of any shape or size and may contain any number of sealing elements. Moreover, the sealing element may be offered as a replacement/upgrade to existing equipment or as a new part in new equipment.

As used herein, elastomeric material means a material or substance having one or more elastomers, an elastomeric compound or compounds used together, or a combination of elastomer or elastomeric compounds with other substances. The elastomeric material used in connection with the subject invention does not have to be a single type of elastomer, but may be a compound or combination of substances as described below. Hence, the sealing element may be made entirely of elastomer or as a composite where the elastomer may be bonded to or combined with other materials for improved mechanical properties.

Elastomers or elastomeric materials suitable for use in connection with the subject invention include any of various elastic substances resembling rubber such as synthetic rubbers, fluoro-elastomers, thermoset elastomers and thermoplastic elastomers. Elastomers have, by definition, a certain level of elasticity, that is, the property by virtue of which a body resists and recovers from deformation produced by force. Hence, the elastic limit of such material is the smallest value of the stress producing permanent alteration. Elastomers have the inherent ability to dissipate energy from shocks and collisions.

The elastomeric material may be varied as necessary to satisfy the operating conditions of a particular application. Softer or harder compounds may be required or different mechanical properties may be required to meet the various service needs experienced by the reciprocating gas compressor valve. In addition, corrosion resistance and chemical attack may mandate different material blends. One skilled in the art will rely on experience and published data to make a proper material selection.

The hardness of elastomeric material is typically measured using the “Shore” scale. The Shore scale was developed for comparing the relative hardness of flexible elastomeric materials. The unit of measure is the “durometer”. An analogous scale would be the “Rockwell” or “Brinell” scales used in measuring the hardness of metals.

The use of elastomeric material as the sealing element of a reciprocating gas compressor valve has a number of benefits. One important benefit is a better gas tight seal within the reciprocating gas compressor. Elastomeric materials by their nature flex and conform to surfaces that they come into with. Hence, a second benefit is a durable, gas tight seal with irregularities in the seat surface. Another benefit is that the elastomeric material absorbs shock or the forces between the sealing element and the seat, reducing the potential of impact damage of either element and increasing the useful life of the compressor valve. The elastomeric material is also resilient so as to minimize the damage caused by entrained liquids or solid debris that may be in the gas stream. Time between reciprocating gas compressor valve failure is increased. Other benefits of the invention will become clear from the description of the invention.

Still other objects, features, and advantages of the present invention will be apparent from the following description of the preferred embodiments, given for the purpose of disclosure, and taken in conjunction with the accompanying drawings.

### BRIEF DESCRIPTION OF THE DRAWINGS

FIG. 1A is a top view of a sealing element for a ported plate valve.

FIG. 1B is a cross sectional view of the sealing element for the ported plate valve of FIG. 1.

FIG. 2 is a cross sectional view of a sealing element for a ported plate valve.

FIG. 3 is a cross sectional view of a sealing element for a concentric ring valve.

FIG. 4A is a cross section view of a sealing element for a concentric ring valve.

FIG. 4B is the sealing element of FIG. 4A depicting a line contact between the sealing surface and the sealing element.

FIG. 5A is a cross section view of a sealing element for a single element non-concentric ring valve.

FIG. 5B is the sealing element of FIG. 5A depicting a surface contact between the sealing surface and the sealing element.

FIGS. 6A-H is a side view of various types of sealing elements used in a single element non-concentric ring valve also known as poppet valves.

FIG. 7A is a schematic of a typical gas compressor.

FIG. 7B is a front view of the typical gas compressor of FIG. 7A.

FIG. 8 is a two dimensional graph depicting deflection of a sealing element when subjected to a pressure load.

FIG. 9 is a two dimensional graph depicting deflection of a sealing element when subjected to a pressure load.

### DETAILED DESCRIPTION OF THE INVENTION

The subject invention is a sealing element 30 of a reciprocating gas compressor valve having at least one elastomeric layer 32 made from an elastomeric material. “Gas” as used herein means any compressible fluid. The sealing element may have multilayers of elastomeric material, or may be constructed entirely of elastomeric material. The elastomer layer 32 may be a coating applied to the sealing element 30 using bonding materials in a variety of methods well known in the relevant art. The bonding and primer agents are commercially available.

For example, one bonding material used in connection with the subject invention that bonds Mosites fluoroelastomer to a PEEK substrate is a commercially available product known as Dynamar 5150. Bonding is improved by the addition of an epoxy adhesive known as Fixon 300301, a two-part epoxy. Fixon was applied at the time the elastomeric material was compression molded and after the primer, Dynamar 5150, was applied and dried on the PEEK substrate. Another bonding material used to bond 58D urethane to a PEEK substrate is known as PUMTC405TCM2, a proprietary bond/primer provided by Precision Urethane.

The ability of elastomeric materials to bond to other materials varies and depends on a number of factors. Generally, elastomers will adhere to a surface that is clean and dry. Therefore, a degreasing operation using a volatile commercial solvent by wiping or spraying the surface may be necessary. Surface adhesion can be modified by sand/bead blasting, scratching with sandpaper or by eliminating the fine surface finish requirements of the non-elastomeric part. By roughing the surface, more surface area is provided for elastomer bonding. Bonding between elastomeric and non-elastomeric parts can be achieved or enhanced by coating the non-elastomeric part with a primer that is compatible with both materials. The purpose of the primer is to react chemically or thermally with the two materials to improve or create the bond. These bonding procedures have been described using one elastomer and one non-elastomer, but may be used for any number of materials metallic and nonmetallic in the composite form.

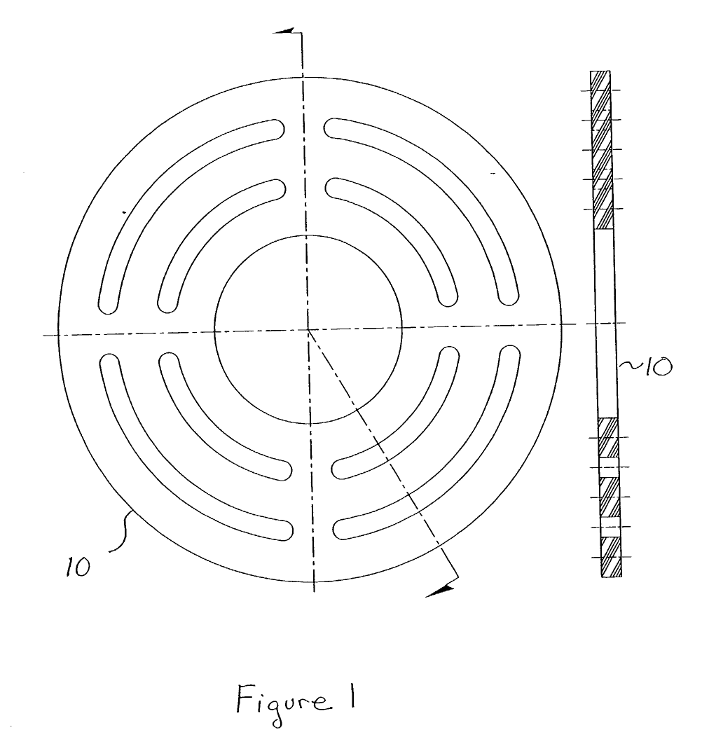

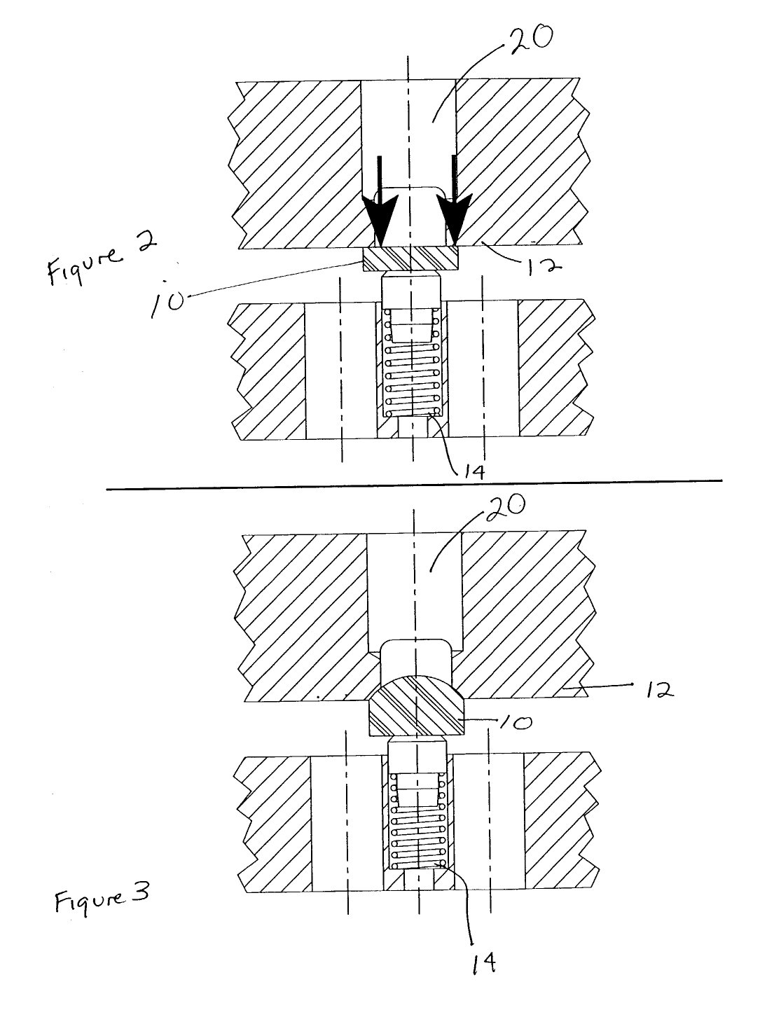

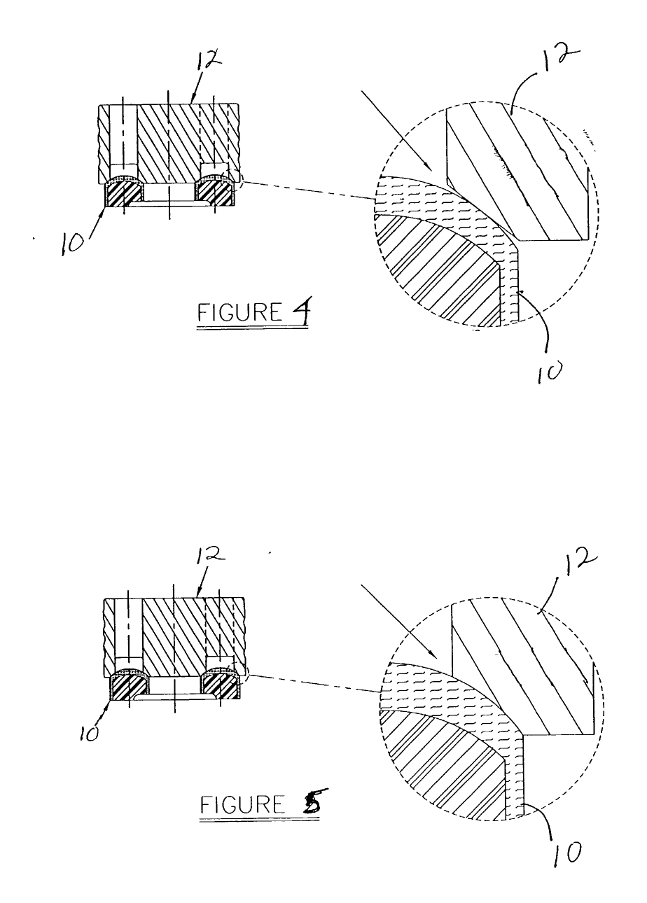

Currently, reciprocating gas compressor valves utilize several types of sealing elements. As shown in FIGS. 1, 2, 3 and 6, three common forms of valves used in reciprocating gas compressors are: concentric ring (FIG. 3), single element non-concentric (FIG. 6) and ported plate (FIGS. 1 and 2). Concentric rings are typically set equal in distance from one another, but the distance between rings may or may be not fixed and can vary depending on the manufacturer. The distance between the rings depends on the design of the valve. Concentric rings may be simply flat plate with a rectangular cross section or they be made into special shapes (non-rectangular cross sections) for the purposes of achieving better aerodynamic efficiency or an improvement in the longevity of the seal. Metallic or non-metallic materials are common. U.S. Pat. No. 3,536,094 to Manley teaches a concentric ring type of valve.

Ported plate valves are very similar to concentric ring valves in that there are multiple rings but the rings are all connected via narrow webs. The effect is to create a single sealing element of interconnected concentric rings. An example of a ported plate valve can be found in U.S. Pat. No. 4,402,342 to Paget. The sealing element of the ported plate valve may be nearly any size and geometry. However, in almost all cases, the sealing element of the ported plate valve is flat on both sides and has areas machined out where gas is intended to flow. Machining out the areas where the gas flows essentially creates the webs that interconnect the concentric ring of the plate. Some manufacturers create molds to produce the finished sealing element in an attempt to reduce machining costs. Opinions vary as to whether molding the sealing element of the ported plate produces a quality part in terms filler or fiber alignment in the finished product.

Some of the advantages of the ported plate are that the springs that support the sealing element act on the entire sealing element rather than just the ring under which they are placed. Since the rings are all connected, the design permits the use of larger and possibly fewer springs than a valve with concentric rings that are not all connected. In non-connected concentric ring valves, the individual rings are supported by their own springs and generally the diameter of the springs is limited to the width of the particular sealing element or ring.

Ported plate valves operate in a slightly different manner than non-connected types. While the basic function is the same (to alternately open and close), the gas dynamics in the reciprocating gas compressor cylinder are such that flow through a compressor valve is rarely perfect. In other words, because of the various geometries of the gas compressor cylinders themselves, the gas forces acting on the ported plate may not be equally distributed across the entire plate and one side of the plate may open ahead of the other side. The sealing element may tip to some angle rather than moving in a motion that is purely perpendicular to the sealing surface. While this is not necessarily detrimental to performance, the sealing element the strikes the guard or stop plate or sealing surface at some angle other than perpendicular can suffer edge chipping which can lead to fractures of the ported plate valve. Conversely, concentric ring valves are less susceptible to the problems associated with edge chipping but it does occur. The operation of the concentric ring valve permits the individual rings to operate independently of one another. Opinions vary as to which functions better but they are both widely used and are very effective designs.

Ported plate valves and concentric ring valves are generally known to have rather large flow areas and lower pressure drops, representing efficiency advantages. However ported plate valves, by their nature, are difficult to form into aerodynamic shapes. What cannot be achieved with improved aerodynamics is achieved with more generous flow areas. Concentric rings as used in the MANLEY® valve can be made into aerodynamic shapes and the minor loss in flow area can be restored with better aerodynamics. The function is the same, but the path to achieve it is slightly different.

On the other hand, single element, non-concentric valves do not usually suffer from edge chipping because the diameter of the elements is small and guides within the valve seat or guard prohibit the element from tipping far enough for edge chipping to be a problem. The potential for edge chipping increases with diameter. Single element, non-concentric valve elements can be made into aerodynamic shapes as well.

The single element non-concentric type of valve includes the poppet type of valve shown in FIG. 6, and the MOPPET® valve as shown and described in U.S. Pat. No. 5,511,583 and other valves where the sealing element has a shape that fits into the available area of the valve seat. The diameter of the valve and the size of the sealing element determine the number of elements that can be fitted into the available area. A wide variety of shapes and element cross sections are available and depend on manufacturer design. Often use of single element, non-concentric element types have a single spring device that controls its motion as opposed to a concentric ring design in which a single ring or plate is supported by a number of springs. As noted the purpose of the spring is designed to close or to begin to close the sealing element before the piston reaches top or bottom dead center. Differential pressure opens and closes the valve. Springs are relevant to the dynamics of the valve element motion and they are a critical component in the valve; however, they are not relevant to the sealing characteristics of the valve elements. When the valve is in actual service, differential pressure forces dwarf the spring forces.

While the valves may vary in structure, the function of the sealing element of any type of valve is to create a reliable gas tight seal after each closing event of the valve after many repetitions. The sealing element used in any type reciprocating gas compressor valve serves the same function. In spite of the differences in geometry and design, all valve elements are made to: a) produce a gas tight seal when the valve is in the closed position; b) survive the rigors of successive impacts with the sealing surface when the valve changes from open to a closed position; c) survive and tolerate as much as possible impacts and damage caused by liquids and or solid debris entrained in the gas stream; d) seek to increase the mean time between valve failures so as to minimize unscheduled compressor shutdowns for valve repair where doing so increases revenue potential for the operator of the compressor and lowers operating costs; e) be cost effective; f) be easy to install and minimize the time needed to repair or refurbish; and g) be aerodynamic so as to minimize pressure drops (losses) as the gas flows through the valve. Pressure drops are essentially “friction” that must be overcome by the reciprocating gas compressor driver. Reducing pressure drops increases operating efficiencies by saving fuel and/or electricity.

Hence, sealing elements able to perform for long periods of time and over many cycles are considered reliable and are desired as the operating availability of the compressor is improved. Fewer unscheduled equipment failures reduce operating costs for the equipment and increase the revenue generating ability of the equipment. Noteworthy, surfaces other than the sealing surface and the sealing element make contact during opening events. Therefore, impacts and damage may occur not as a result of the impact of the sealing element. Surfaces that collide during the opening event do not influence or degrade the ability of the valve to seal unless the valve element should fracture or otherwise lose its shape.

The elastomeric materials to be used in connection with the sealing element of the subject invention include, but are not limited to, natural rubber, styrene butadiene, synthetic rubber, and polymers such as thermoplastic elastomers (TPE), thermoset elastomers, and fluoro-elastomers, elastomeric copolymers, elastomeric terpolymers, elastomeric polymer blends and a variety of elastomeric alloys. The particular type of elastomeric material utilized depends in part on the application A variety of commercially available elastomeric materials are useful with the subject invention. For example, butyl elastomer sold under the trade names of EXXON Butyl (Exxon Chemicals) or POLYSAR (Bayer Corp) performs well for MEK, silcone fluids and greases, hydraulic fluids, strong acids, salt, alkali and chlorine solutions. Ethylene and propylene are often substituted for butyl. Chloroprene sold under the trade names of BAYPREN (Bayer Corp) and NEOPRENE (DuPont Dow) performs well in petroleum oils with a high aniline point, mild acids, refrigeration seals (having resistance to ammonia and Freon), silicate ester lubricants and water. Chloroprene is also known as polychloroprene having a molecular structure similar to natural rubber. Similarly, chlorosulfonated polyethylene sold as HYPALON (DuPont Dow) performs well with acids, alkalis, refrigeration seals (resistant to Freon), diesel and kerosene. Chlorosulfonated polyethylene has good resilience and is resistant to heat, oil, oxygen and ozone. Epichlorihydrin sold under the trade name of HYDRIN (Zeon Chemicals) performs well in air conditioners and fuel systems. Epichlorihydrin is oil resistant and often used in place of chloroprene where low temperatures are a factor, having better low temperature stiffness. Ethylene Acrylic sold under the trade name of VAMAC (DuPont Dow) performs well in alkalis, dilute acids, glycols and water. This rubber is a copolymer of ethylene and methyl acrylate and has a low gas permeability and moderate oil swell resistance. Also, ethylene acrylic has good tear, abrasion and compression set properties. Ethylene propylene sold under the trade names of BUNA EP (Bayer Corp), KELTAN (DSM Copolymer), NORDEL (DuPont Dow), ROYALENE (Uniroyal) and VISTALON (Exxon Chemical) resists phosphate ester oils (Pydraul and Fyrquel), alcohols, automotive brake fluids, strong acids, strong alkalis, ketones (MEK, acetone), silicone oils and greases, steam, water and chlorine solutions. EPDM is, for example, a terpolymer made with ethylene, propylene, and diene monomer. Fluoro-elastomers sold under the names of DAI-EL (Daiken Ind.), Dyneon (Dyneon), Tecnoflon (Ausimont) and VITON (DuPont Dow) perform well in acids, gasoline, hard vacuum service, petroleum products, silicone fluids, greases and solvents. Fluoroelastomers have a good compression set, low gas permeability, excellent resistant to chemical and oils. Having high fluorine to hydrogen ratio, these types of compounds have extreme stability and are less likely to be broken down by chemical attack. Fluorosilicone sold under the trade names of FE (Shinco Silicones), FSE (General Electric) and Silastic LS (Dow Corning) performs well as static seals due to high friction, limited strength and poor abrasion resistance and particularly with brake fluids, hydrazine and ketones. Hydrogenated Nitrile sold under the trade names of THERBAN (Bayer Corp.) and ZETPOL (Zeon Chemicals) performs well in hydrogen sulfide, amines (ammonia derivatives), and alkalis, and under high pressure. Hydrogenated Nitrile is often used as a substitute for FKM materials and has high tensile properties, low compression set, good low temperature properties and is heat resistant. Natural rubber performs well in alcohols and organic acids and has high tensile strength, resilience, abrasion resistance and low temperature flexibility in addition to having a low compression set. Nitrile sold under the trade names of KRYNAC (Polysar Intl), NIPOLE (Zeon Chemicals), NYSYN (Copolymer Rubber and Chemicals) and PARACRIL (Uniroyal) performs well in dilute acids, ethylene glycol, amines petroleum oils and fuels, silicone oils, greases and water below 212° F. Also known as Buna-N, nitrile is a copolymer of butadiene and acrylonitrile. Perfluoroelastomer sold under the trade name AEGIS (International Seal Co.), CHEMRAZ (Greene Tweed), KALREZ (DuPont Dow) has low gas permeability and is resistant to a large number of chemicals including fuels, ketones, esters, alkalines, alcohols, aldehydes and organic and inorganic acids and exhibits outstanding steam resistance. Polyurethane sold under the trade names of ADIPRENE (Uniroyal), ESTAE (B. F. Goodrich), MILLITHANE (TSE Ind.), MORTHANE (Morton International), PELLETHANE (Dow Chemical), TEXIN (Bayer Corp.) and VIBRATHANE (Uniroyal) performs well under pressure, is very tough and has excellent extrusion and abrasion resistance. Silicone sold under the trade names of BAYSILONE (Bayer Corp.), KE (Shinco Silicones), SILASTIC (Dow Corning), SILPLUS (General Electric) and TUFEL (General Electric) performs well in oxygen, ozone, chlorinated biphenyls and under UV light. Silicones have great flexibility and low compression set. Tetrafluoroethylene (“TFE”) sold as ALGOFLON (Ausimont) and TEFLON (DuPont Dow) performs well in ozone and solvents including MEK, acetone and xylene. Tetrafluroethylene/propylene is a copolymer of TFE and propylene sold under the trade names of AFLAS (Asahi Glass), and DYNEON BRF (Dyneon). Tetrafluroethylene/propylene performs well in most acids and alkalis, amines, brake fluids, petroleum fluids, phosphate esters and steam.

As shown in the examples below, VITON®, a material developed by DuPont that is in the family of fluoro-elastomers is utilized as an elastomeric material. Chemically it is known as a fluorinated hydrocarbon. VITON® comes in several grades A, B, and F in addition to high performance grades of GB, GBL, GP, GLT, and GFLT.

Some of the physical properties of VITON® are as follows:

| | |
|---|---|
| Durometer Range on the Shore scale | 60-90 |
| Tensile Range | 500-2000 psi |
| Elongation (Max %) | 300 |
| Compression set | GOOD |
| Solvent Resistance | EXCELLENT |
| Tear Resistance | GOOD |
| Abrasion Resistance | GOOD |
| Resilience-Rebound | FAIR |
| Oil Resistance | EXCELLENT |
| Low Temp range | −10 F. |
| High Temp Range | 400-600 F. |
| Aging-weather and sunlight | EXCELLENT |

VITON® provides chemical resistance to a wide range of oils, solvents, aliphatic, aromatic, and halogenated hydrocarbons, as well as to acids, animal and vegetable oils.

As also discussed in the examples, urethane is a thermoset elastomer as previously discussed. Some of the relevant properties of urethane are as follows:

| Durometer Range on the Shore scale | 68A-80D |
|---|---|
| Tensile Range | 2100-9000 psi |
| Elongation | 150-885 |
| Compression set | 15-45% |
| Modulus 100% | 330-7800 |
| Modulus 300% | 470-8400 |
| Tear Strength Die C. pli | 205-1380 |
| Tear Strength Split, pli | 55-476 |
| Bayshore Rebound | 18-58% |
| Cured Density | 1.07-1.24 |

Generally, thermoplastic elastomers (TPE) as defined in the Modern Plastics Encyclopedia (1997, 1998) are “soft flexible materials that provide the performance characteristics of thermoset rubber, while offering the processing benefits of traditional thermoplastic materials”. Hence, the thermoplastic material, a typically rigid material, is modified at the molecular level to become flexible after molding. TPE materials are popular because they are easy to make and mold.

The mechanical and physical properties of TPE's are directly related to the bond strength between molecular chains as well as to the length of the chain itself. Plastic properties can be modified by alloying and blending in various substances and reinforcements. The ease at which TPE's can be modified is a distinct advantage of these materials. The mechanical properties of these materials can be customized to suit a particular application or service.

Thermoset elastomers are plastic substances that undergo a chemical change during manufacture to become permanently insoluble and infusible. Thermoset polymers are a subset of thermoset elastomer material as these materials undergo vulcanization enabling them to attain their properties. The key difference between a thermoset elastomer and a thermoplastic elastomer is the cross-linking of the molecular chains of molecules that make up the material. Thermoset materials are cross-linked and TPE materials are not.

The family of preferred fluoro-elastomers may be subdivided into seven categories:

1) copolymers meaning combinations or blends of two polymers;

2) terpolymers meaning combinations or blends of three polymers. These typically have good heat resistance, excellent sealing and good chemical resistance;

3) low temperature polymers, which have good chemical resistance and excellent low temperature properties;

4) base resistant polymers, which have superior chemical resistance to bases, aggressive oils and amines;

5) peroxide cure polymers, which have superior chemical resistance and excellent sealing properties;

6) specialty polymers; and

7) perfluorinated polymers, which have superior chemical resistance and excellent sealing properties.

Copolymers are materials made up of two or more different kinds of molecule chains. They are basically a combination of different materials fused into one. The individual compounds that make up the molecular chain are distinct and repeating over the length of the molecular chain. A terpolymer is a copolymer with three different kinds of repeating units. A homopolymer identifies a polymer with a single type of repeating unit. Other repeating units are possible as well. Alloys are elastomers with additives that improve the properties of the material, much like metal alloys.

Well known to those skilled in the art, the utility of rubber and synthetic elastomers is increased by compounding the raw material with other ingredients in order to realize the desired properties in the finished product. For example vulcanization increases the temperature range within which elastomers are elastic. In this process, the elastomer is made to combine with sulphur, sulphur bearing organic compounds or with other chemical crosslinking agents. Any number of ingredients can be combined in any number of ways to generate any number of mechanical or chemical properties in the finished elastomeric material.

In general, the elastomeric materials useful in the subject invention operate within the following ranges:

TEMPERATURE=−120° F. to 450° F.

PRESSURE=vacuum to 12,000 psi

DIFFERENTIAL PRESSURE=0 to 10,000 psi

SERVICE TYPE=Continuous or intermittent duty in any type of compressible gas or gas mixture.

OPERATING EQUIPMENT=Reciprocating gas compressors in any industry from any manufacturer of reciprocating gas compressors.

These ranges are typical for reciprocating gas compressors. Other elastomers can operate in more extreme temperatures and pressures depending on the characteristics of the elastomeric material used.

Other important characteristics of the elastomers are:

durometer range on the Shore scale or analogous scale, which is a measure of the hardness of the elastic material.

tensile strength, which is the approximate force required to make a standard material sample fail under a tensile load.

elongation, which is the amount of deformation that a sample will exhibit before failure. An elongation of 200% indicates that the sample will stretch 2 times its original length before failure.

compression set, which is a measure of the elastic materials ability to withstand deformation under constant compression.

solvent resistance, which indicates a compound's resistance to solvents that normally dissolve or degrade elastomers in general.

tear resistance, which is the ability of the elastic material to withstand tearing and shear forces.

abrasion resistance, which is the ability of the elastic material to withstand abrasion and rubbing against another material or itself.

rebound resilience, which is the measure of the ability of an elastic material to return to its original size and shape after compression.

oil-resistance, which is the relative ability of an elastic material's resistance to penetration or degradation by various hydraulic or lubrication oils commonly used in industrial services. Many reciprocating gas compressors have lubricated compressor cylinders.

aging, weather, and sunlight resistance, which is the ability of the elastic material to withstand the elements. This is not a factor in this particular use because the elastic materials will be inside of machine components.

Hence, the specific elastomeric material used for the elastomeric layer will be dictated by requirements of the reciprocating gas compressor and the compressor valves. In a chemical rich environment, an elastomer, such as a peroxide-cured polymer, having superior chemical resistance properties is required. Similarly, unusual temperature environments mandate certain appropriate properties. Engineers and individuals experienced with gas compression may analyze a particular set of operating parameters and select a material with the appropriate properties. For this reason, there will necessarily be a large number of potential elastomer compounds that may be selected or custom designed to perform in a particular set of operating conditions. The blending and the ability to modify the mechanical and chemical properties of elastomers and/or thermoplastics offer an extensive array of possible solutions to any gas compression application. This key advantage of elastomers will yield high performance solutions to common or difficult applications where none existed previous to this invention.

Examples of reciprocating gas compressor valves useful in the practice of the subject invention include U.S. Pat. No. 3,536,094 to Manley (also known as the MANLEY® valve), and U.S. Pat. No. 5,511,583 to Bassett. The teachings and disclosures of these patents are incorporated herein by reference as if fully set out herein. The MANLEY® valve is a concentric ring type of valve constructed of non-metallic thermoplastic resin. In this type of valve, the sealing element thickness may vary by design with rounded or straight vertical edges. The MANLEY® valve has a downwardly convex protruding sealing element to engage a recessed seating surface in the valve seat. U.S. Pat. No. 5,511,583, Bassett discloses the MOPPET® valve, a single element non concentric valve. When open fluid flows over the inner and outer annuls of the sealing element. The MOPPET® sealing element is different than the poppet valve sealing element (FIG. 6). In the MOPPET® valve, fluid flow travels through both an inner annulus and an outer annulus of the sealing element. In a poppet valve, fluid flows over the outer annulus of the sealing element only because it does not have a center hole.

The sealing element of the subject invention may be of various forms and types when utilized in reciprocating gas compressor valves. Generally, as depicted in the Figures, a reciprocating gas compressor valve comprises a sealing element 10 and a seating surface 12 having an opening 20 for intake and exhaust of gas. The seating surface 12 surrounds the periphery of the opening 20. The sealing element 10 is sized and shaped to correspond with, and fully close the opening 20 when engaged against the seating surface 12. The seating surface 12 may be part of a sealing element 10. For example, the elastomeric material may be applied under the appropriate circumstances to the seating surface 12 either in combination with the sealing element 10 or alone.

The intake or exhaust gas flows into or out of the reciprocating gas compressor through the opening 20. Operation of the reciprocating gas compressor requires that the opening 20 of the reciprocating gas compressor valve be alternately opened and closed. The opening 20 is closed when the sealing element 10 is moved into contact with the seating surface 12 and closes the opening 20. When the sealing element 10 is moved out of contact with the seating surface 12, the opening 20 is opened and gas is permitted to flow into or out of the reciprocating gas compressor cylinder depending on whether the valve is located in the suction or discharge position of the reciprocating gas compressor cylinder.

The opening 20 and sealing element 10 are often cylindrical or spherical; however, the opening 20 and sealing element 10 of reciprocating gas compressor valve may be of any geometric configuration. The only requirement is that the size and shape of the sealing element 10 must correspond to the opening 20 in order to effectuate a seal.

The movement of a sealing element 10 is often limited by a guard (also referred to as a “stop plate”). Typically, the reciprocating gas compressor geometry is such that when the seat plate 10 and the guard are joined together, there is space available between the two for the sealing element 10 to move away from the seating surface 12 and against the guard. In modern reciprocating gas compressor designs it is possible to control the total travel of the sealing element 10 by adjusting the geometry of the guard and/or varying the thickness of the sealing element 10. The distance traveled by the sealing element is generally decided by the manufacturer of the reciprocating gas compressor valve after analysis of the operating conditions. While the distance is generally not a concern, there is a historical pattern suggesting that valves with sealing elements with high travel distances have a lower time between failures than valves with low travel distances. This is likely because the greater travel distance permits more time for the sealing elements to accelerate and thereby increasing the impact velocities described previously.

In almost all current compressor valve designs a mechanism is in place (usually a spring) that is placed in the guard for the purpose of pushing the sealing element 10 toward the seating surface 12. In other words, the spring or some other device will push the sealing element 10 against the seating surface 12, resulting is a gas tight seal when the compressor valve is in a static, non-pressurized condition. During operation the purpose of the spring 14 or other mechanism is to push the sealing element 10 toward the seating surface 12 at some point in time before the compressor piston reaches top or bottom dead center. By varying the spring forces, the valve designer can influence the velocity of valve sealing elements and thereby control (to some extent) the impact forces between the seat and sealing element.

Top or bottom dead center refers to the position of the compressor piston within the compressor cylinder. Since reciprocating gas compressor cylinders may be double acting, the reference to top or bottom dead center is relevant only after it is determined which end of the compressor cylinder is being analyzed. When the piston reaches top or bottom dead center at the conclusion of the discharge or suction stroke, the piston changes direction, and pressures inside the compressor cylinder reverse. Pressure that was increasing starts to decrease (and vice versa) as soon as the piston reverses direction. If this occurs and the valve sealing element(s) is some distance away from the sealing surface the valve sealing element(s) can be forced against the seat plate in a violent manner by the changing gas pressure. Differential pressure forces can be substantial. A spring or other suitable mechanism is installed behind the sealing element 10 to push the sealing element 10 toward the seating surface 12 well before top or bottom dead center such that the pressure changes resulting from the change in direction of the compressor piston do not accelerate the valve sealing elements to excessive or destructive speeds.

Technology and trends in reciprocating gas compressor philosophy have resulted in smaller reciprocating gas compressors being operated at higher speeds. Typically reciprocating gas compressors in industrial process services were operated at piston speeds no higher than about 800 ft/min. Piston speed is a function of crankshaft speed, and compressor stroke. Piston speeds have been set by convention (see API-618) as a means for increasing the mean time between failures of not only the compressor valves but other compressor components. Recently these slow speed philosophies have been abandoned for high speed, short stroke reciprocating gas compressors. As speed increases, there is necessarily less time for a compressor cylinder to expel compressed gas or admit new gas before the piston reaches top dead center. This effectively reduces the time available for the compressor valve elements to travel their full allowable distance. The increase in speed has resulted in an increase in the impact forces between the seating surface 12 and the sealing element 10, which results in a decrease in the mean time between failures of the valve seating surface 12 or sealing element 10. In addition, faster rotating speeds result in a considerable increase in the number of opening and closing events over a given time period. This results in a decreased useful life of the compressor valve and possibly also the reciprocating gas compressor.

The novel use of elastomeric compounds as the sealing element in valves is applicable for use in reciprocating gas compressors that are driven by electric motors, gas or liquid fuel engines, steam turbines or any other energy conversion device that provides power to a shaft for the purposes of imparting a rotating motion to a crankshaft. The reciprocating gas compressor may be directly coupled or indirectly coupled to the driver through the use of gears, belts, etc.

All reciprocating gas compressors are fundamentally the same. They are built with one or more compressor cylinders attached to a common crankshaft for the purpose of raising the gas from one pressure to another higher pressure. The reciprocating gas compressors may operate as a single stage unit or they can be designed for multistage operation. The gas cylinders can be oriented in any direction in relation to the crankshaft or to each other. Reciprocating gas compressors may be designed to operate in series or parallel with other compressors.

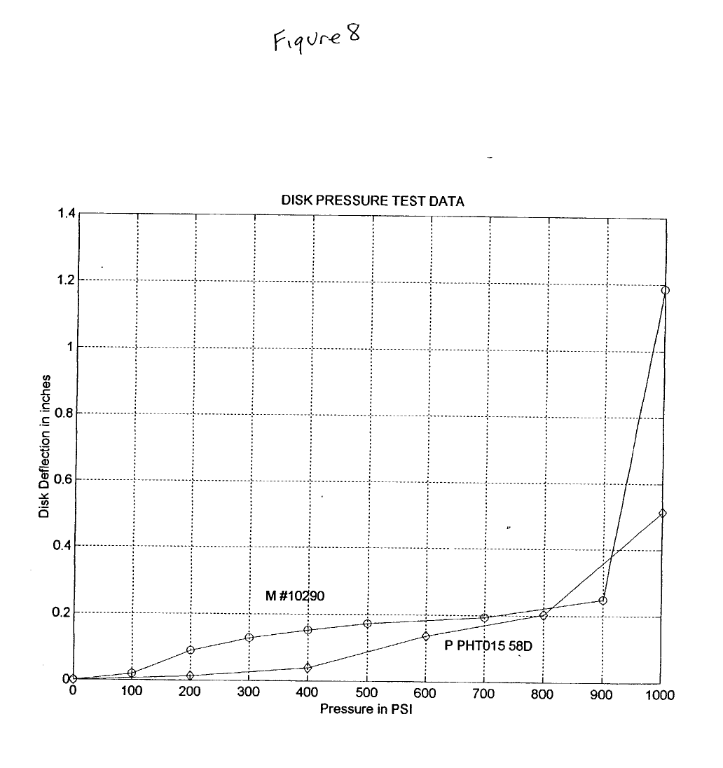

There are many manufacturers of reciprocating gas compressors. Each gas reciprocating gas compressor, however, performs the same task but varies in form and size. Currently known manufacturers of reciprocating gas compressors include: ABC Compressor; Ajax (Cooper); Aldrich Pump; Alley; Ariel; Atelier Francois; Atlas Copco; Bellis & Morcam; Blackmer Pump; Borsig; Broomwade; Bryn Donkin; Burckhardt; Burton Corbin; C. P. T.; Chicago Pneumatic; Clark; Consolidated Pneumatic; Corken; Crepelle; Creusot Loire; Delaval; Demag; Du Jardin; Ehrardt & Schmer; Einhetsverdichter; Energy Industries; Essington; Framatome; Frick Bardieri; Gardner Denver; Halberg; Halberstadt; Hitachi; Hofer; IMW; Ingersoll Rand; Ishikawajima-Harima Heavy Industries (IHI); Iwata Tosohki; Japan Steel Works; Joy; Kaji Iron Works; Khogla; Knight; Knox Western; Kobe Steel; Kohler & Horter; Mannesmann Meer; Mehrer; Mikuni Heavy Industries; Mitsubishi Dresser; Mitsui; Neuman & Esser; Norwalk; Nuovo Pignone; Pennsylvania Process Compressor (Cooper); Pentru; Penza; Peter Brotherhood (FAUR); Quincy; Reavell; Sepco; Siad; Suction Gas Engine Company; Sulzer; Superior (Cooper); Tanabe; Tanaise; Thomassen; Thompson; Undzawa Gumi Iron Works; Vilter; Weatherford Enterra (Gemini); Whitteman; and Worthington. FIGS. 7a and 7b shows a typical arrangement and design of a reciprocating gas compressor. Generally, each reciprocating gas compressor has a driver 16, a frame 18, a throw 22, at least one compressor cylinder with a crank end 24 and a head end 26, suction valves 28 and discharge valves 30, or valves that are combination suction and discharge valves (not shown).

### EXAMPLE 1

As a first field test, a 1400 rpm Ariel reciprocating gas compressor was used in gas gathering service. This machine is desirable for testing the sealing element of the subject invention because of its rotating speed. A large number of opening and closing cycles may be accumulated in a short period of time. In this initial test, 90 durometer fluoro-elastomer, Mosites was applied to a nylon disk and used in a MOPPET® valve. The materials ran for six (6) days before failure occurred. Inspection of the parts indicated that the nylon base material melted and subsequent deformation of the parts and loss of seal, resulted in overheating and forced a shutdown of the compressor.

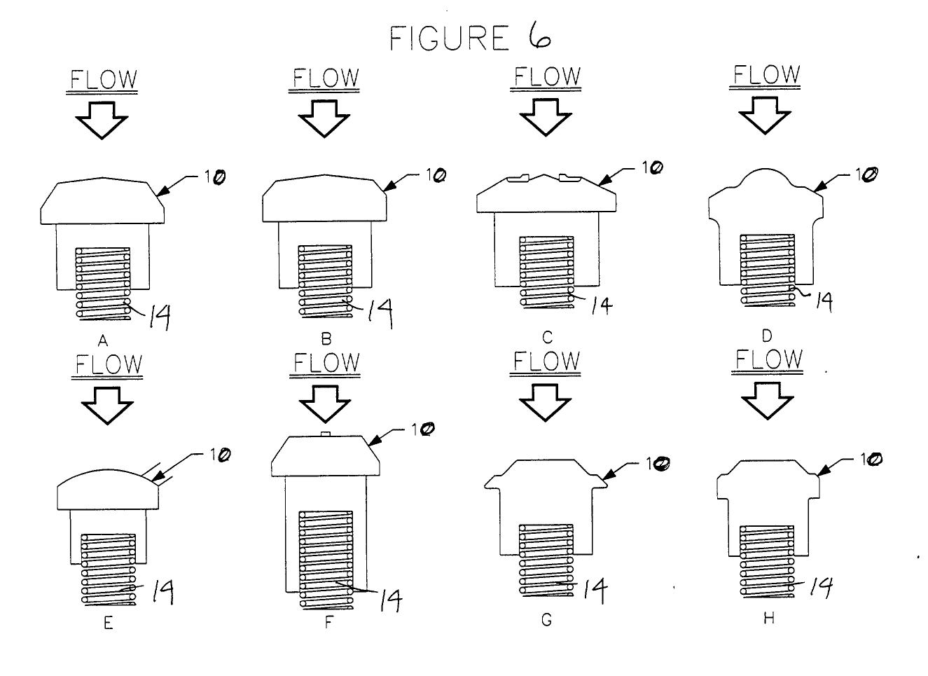

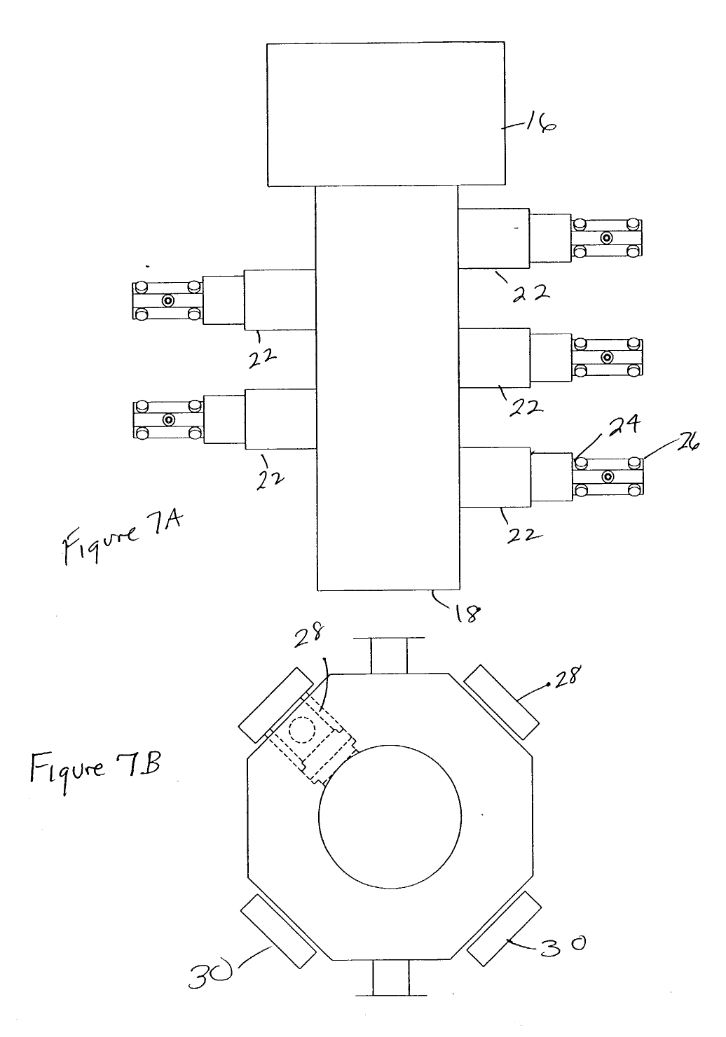

Nylon is no longer being used as a base material. PEEK has been applied as a result of its ability to operate at higher temperatures. The same elastomeric material, Mosites, was applied to the PEEK disks and the parts were run again. The parts ran for about 205 days before failure occurred. The standard product (PEEK) without a layer of elastomeric material operated for eight (8) months. The parts were, for the most part, destroyed. However, two sealing elements were intact and showed minimal wear. As shown in FIGS. 4 and 5, the line of contact made by the sealing element with the seating surface may create a local high stresses in the elastomer. The sealing element suffered higher contact loads, resulting from the line contact. It was resolved to change to a surface type of contact. Notwithstanding, the sealing element was soft and flexible and the bond between the elastomeric material and the PEEK held up well. In this Example, the reciprocating gas compressor specifications were as follows:

| | |
|---|---|
| Suction Pressure = 300 psi | Discharge Pressure = 540 psi |
| Suction Temperatures = 80° F. | Discharge Temperatures = |
| | 200° F. |
| Sealing Element Travel = 0.160 inches | RPM = 1350 |
| Compressor: Ariel IGE | Gas: Wellhead Gas (mixture |
| | of mostly methane and |
| | other hydrocarbons) |

### EXAMPLE 2

In the first test of the urethane material, the material failed in four (4) days and inspection revealed that the bond between the urethane and the PEEK material permitted the urethane to separate from the PEEK at discharge temperatures. In addition, the PEEK used in this test had been colored black by the addition of carbon which has the detrimental effect of making the thermoplastic material slippery. The MOPPET® valve parts were essentially undamaged but it was clear the bonding chemical between the urethane and the plastic allowed the urethane to separate. The suction valves were intact and in good condition because the suction temperatures are much lower than discharge temperatures. It seemed clear that the bonding agent had temperature limitations. Other bonding agents capable of withstanding higher temperatures must be utilized.

It should be noted that the standard valve (without the use of elastomeric material) began to overheat in only a few hours before having to be removed. While the urethane failed prematurely, it should be noted that while the valve parts were intact the temperatures were normal and operation was improved with the elastomers. Compressor specifications were:

| Suction Pressure = 43.5 psi | Discharge Pressure = 174 psi | |
|---|---|---|
| Suction Temperatures = 27° F. | Discharge Temperatures = 212° F. | |
| Sealing Element Travel = | RPM = 1188 | |
| 0.120 inches | Gas: | 81% Methane |
| Compressor: Ariel JGH-4 | | 6.9% Ethane |
| | | 4.6% Propane |

### EXAMPLE 3

In this example, the reciprocating gas compressor operated at a rather low compression ratio and the temperatures were low and the urethane sealing element applied to standard (non-black) PEEK ran continuously for over 100 days without problems. This provided the evidence that bonding materials are temperature sensitive. Adhesives and primers able to withstand higher temperatures and new radiused valve seats (surface vs. line contact) were installed. Compressor specifications were as follows:

| Suction Pressure = 503 psi | Discharge Pressure = 783 psi | |
|---|---|---|
| Suction Temperatures = 106° F. | Discharge Temperatures = 169° F. | |
| Sealing Element Travel = | RPM = 327 | |
| 0.120 inches | Gas: | 75.5% Hydrogen |
| Compressor: Cooper JM-3 | | 19.5% Methane |
| | | 3.1% Ethane |

### EXAMPLE 4

The elastomers materials are tested in two different services as follows:

1. Flare gas service: This service is characterized by low pressures and dirty gas. Essentially flare gas is made up of all of the gas that leaks from all of the other machines in the plant. Flare gas is a particularly difficult service for compressor valves because the molecular weight and corrosive properties of the gas change frequently over time. This gas is compressed and sent to the flare for disposal. Because of the low pressure, 70 durometer fluoro-elastomer is used. The lower hardness will permit the test pieces to seal more readily at operating pressures. The standard non-black PEEK is being used.

2. Hydrogen service: This service is characterized by high pressures but rather clean gas. Pressures go to 3200 psi with differential pressures approaching 1500 psi. Standard non-black PEEK is being used with a very hard (>90 durometer) compound. The high pressure of this service will put rather high loads on the elastomers and a stiffer compound is required.

Compressor specifications were as follows:

Flare Gas

| Suction Pressure = 0.29 psi | Discharge Pressure = 26.8 psi | |
|---|---|---|
| Suction Temperatures = 150° F. | Discharge Temperatures = 293° F. | |
| Sealing Element Travel = | RPM = 392 | |
| 0.100 inches | Gas: | 60% Hydrogen (Flare Gas) |
| Compressor: IR HHE-VE-3 | | 6% to 17% Methane |
| | | 1% to 5% Ethane |
| Hydrogen Service | | |
| Suction Pressure = 1263 psi | Discharge Pressure = 1825 psi | |
| Suction Temperatures = 112° F. | Discharge Temperatures = 177° F. | |
| Sealing Element Travel = | RPM = 327 | |
| 0.100 inches | Gas: | 79% Hydrogen (Hydrogen |
| Compressor: Clark CLBA-4 | | Service) |
| | | 14% Methane |
| | | 3.6% Hydrogen Sulfide |

### EXAMPLE 5

This service is high pressure hydrogen similar to Example 4. Test pieces were made from standard PEEK with the extra hard fluoro-elastomer material, 80-90 durometer mosites 10290 compound.

Compressor Specifications are as follows:

| Suction Pressure = 1662 psi | Discharge Pressure = 3130 psi | |
|---|---|---|
| Suction Temperatures = 120° F. | Discharge Temperatures = 233° F. | |
| Sealing Element Travel = | RPM = 300 | |
| 0.080 inches | Gas: | 92% Hydrogen |
| Compressor: Worthington BDC-4 | | 6.4% Methane |

### EXAMPLE 6

This application is somewhat different than the others because for the first time the elastomeric material is applied to a ported plate geometry as shown in FIG. 1. Two valve designs notorious for being unreliable are used. Due to the size of the valves, a new valve design was developed that made use of the elastomer. Test pieces were made using standard, non-black PEEK. The mold requires adjustment until the parts are uniform.

In the above examples (field tests), the reciprocating gas compressors were subjected to typical and routine compressor inspections. In both cases, a standard valve using current thermoplastic materials located on an adjacent compressor cylinder was monitored and compared to a cylinder with the new elastomeric materials. The accelerometer traces showed that at both locations, the elastomeric materials lowered the impact energies by approximately two thirds. While the use of elastomers would lead one to expect lower impact energies, the magnitude of the improvement was dramatic and surprising. The reduction of impact energies by the use of elastomers has been verified twice in two separate service conditions and locations.

The elastomeric sealing element made an improvement to the overall reciprocating gas compressor performance. The elastomeric sealing element has less mass than the solid Nylon or PEEK versions and one of the inherent properties of elastomers is that they absorb shock and impact better than other materials. In the field, reciprocating gas compressors can be analyzed during operation and a number of useful parameters can be recorded. With ultrasonic equipment and accelerometers (in addition to pressure and temperature measurements), it is possible to form a rather complete picture of actual reciprocating gas compressor performance.

Ultrasonic equipment can “hear” gas leaking passed the sealing elements in a valve and the accelerometers can detect the magnitude of the impact of the valve elements as they move from full open to full closed. Detecting leaks and the observation of high impact energies permits one to make predictive decisions about the condition of the reciprocating gas compressor and assist in scheduling a maintenance turnaround before catastrophic failures occur.

Since it is unlikely that any one elastomeric material will serve all applications, additional test sealing elements were made using, ethylene/acrylic, styrene/butadiene, hydrogenated nitrile, neoprene, silicone/ethylene propylene, isobutylene/isoprene, natural rubber, tetrafluoroethylene/propylene, carboxylated nitrile, chlorinated polyethylene and ethylene propylene diene monomer (EPDM) elastomers. These parts were made to: (1) prove that they could be attached to the other materials, and (2) to await testing in services where the strengths of the elastomic material can be tested and evaluated.

All of the elastomers were subjected to static pressure testing for the purposes of evaluating their tendency to extrude into the slots (flow areas) of the valve seat. Each of the materials performed well and it should be noted that the hardness of these materials is somewhat less than the 80-90 durometer of the compounds in current field tests. Any small change made in the compounding of these materials will stiffen or soften the material to any desired hardness.

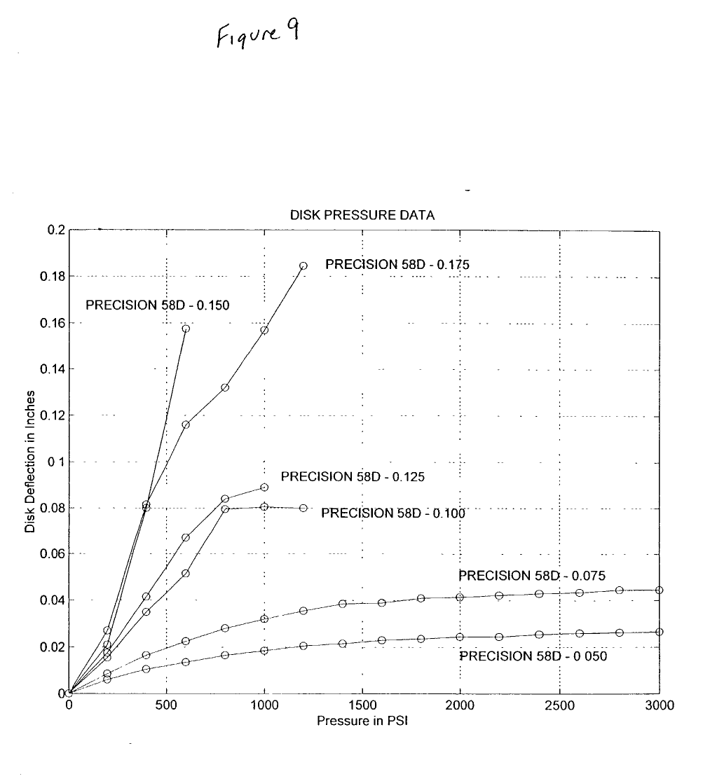

The relevant properties of these and other elastomeric materials are shown in FIGS. 8 and 9. As shown in these figures, use of elastomeric material on the reciprocating gas compressor valve, the impact energies are reduced. FIG. 8 represents data from one of the tests prepared for a single elastomeric sealing element made entirely of elastomer, Mosites 10290 material (fluoroelastomer similar to VITON®) and 58D urethane material produced by Precision Urethane. The elastomeric material was molded into the shape of a MOPPET® sealing element.

The significance of FIG. 8 is that it shows the deflection of the sealing element when subjected to a pressure load. It helps one skilled in the art to determine whether the hardness of material is appropriate for the service. Two samples predictably compress as pressure increases but at about 800 to 900 psid the parts were pushed beyond the sealing surface and into the orifices of the seat itself. Remarkably, upon inspection after the test, the elastomeric material had not ruptured and was recovered in nearly its original shape. The test also revealed that sealing elements comprised completely of elastomeric material would only be effective up to about 600 to 700 psid in actual service conditions, representing only a small part of the total operating envelope that can be addressed with a reciprocating gas compressor. To cover the full spectrum of the desired operating envelope, sealing elements must handle substantially higher pressure differentials. Current production PEEK sealing elements used in MOPPET® valves have been subjected to static differential pressures in excess of 5000 psid with little or no significant deflection.

FIG. 9 shows the deflection versus pressure curves for sealing elements built with an elastomeric material bonded to a nylon or PEEK substrate. At the time of this test, no differentiation was made between the use of PEEK or nylon but subsequent field testing would essentially rule out nylon for use as a candidate for this idea. FIG. 9 has six (6) curves labeled according to the thickness of the elastomer (58D urethane in this case) and the resultant deflection under load. It is clear from the curves that the concept of applying elastomer to a rigid substrate material was the key to surviving high differential pressures. A thick layer of elastomeric material is likely to perform better at lower differential pressures than a thin layer and the test data evidences this.

For most applications, a MOPPET® sealing elements having a 0.100 to 0.050 inches thick layer of elastomeric material covers the widest range of differential pressures. Based on this data and similar curves for the Mosites 10290 material, it was determined that elastomer thickness could be limited to 0.100 or 0.050 inches. Minimizing the number of product variations helps control production costs and makes application of the product easier by limiting the number of available options. This method of testing is useful to measure the potential of other materials that may be suitable for use in compressor valves and aid those skilled in the art to make competent material selections.

In addition to the elastomer layered valves described above, it is believed that other elastomer materials will perform equally in terms of performance since the premise of this idea is to make use of the inherent properties of elastomers. It should be noted that the elastomers herein described have a hardness that is somewhat less than 90 durometer (approximately 70D). However, should a hardness greater than 90 durometers be desired, one can simply make small changes in the compounding of these elastomers to stiffen them to any desired hardness to obtain the desired sealing performance.

In order to determine which elastomer compound can be used for a particular application, static pressure testing can be performed on each elastomer compound or elastomer mixture compound to determine the amount of deflection the elastomeric compound will undergo at certain differential pressure intervals. From this data, the propensity of an elastomeric layered part to extrude into a seat can be determined. One skilled in the art can match the pressure conditions, the results of the static pressure test and historical data to determine the proper elastomeric material to use for the particular application. In addition, consideration of the operating temperatures and the corrosive properties of the gas will influence the material(s) used.

For example, a flare gas service is characterized by low pressure and dirty gas which can vary greatly in composition. Because of the low pressures, a less stiff elastomer compound, such as a 70 durometer fluoro-elastomer, can be used. In comparison, hydrogen service is characterized by high pressure and clean gas with little or no variation in gas composition. Pressures can reach as high as 3200 psi with differential pressures approaching 1500 psi (typical but can go higher). Therefore, a much harder elastomeric material (greater than 90 durometer) seems to be appropriate. An engineer skilled in the art can use the static pressure test results to match the proper compound with each particular service to obtain optimum reciprocating gas compressor performance.

Common engineering elements such as pumps, gauges, controllers, computers, software and the like are not shown or described except when necessary for the understanding of the invention, since for the most part selection and placement of such equipment is well within the skill of the ordinary engineer. Although the above apparatus and process are described in terms of the above embodiments, those skilled in the art will recognize that changes in the apparatus and process may be made without departing from the spirit of the invention. Such changes are intended to fall within the scope of the following claims.

Detailed embodiments of the present invention are disclosed herein. However, it is to be understood that the disclosed embodiments are merely exemplary of the invention that may be embodied in various and alternative forms. The figures are not necessarily to scale where some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

I claim:

1. A sealing element for use in a reciprocating gas compressor valve comprising elastomeric material.

2. The sealing element of claim 1 wherein the reciprocating gas compressor valve is a single element non-concentric valve.

3. The sealing element of claim 1 wherein the reciprocating gas compressor valve is concentric ring valve.

4. The sealing element of claim 1 wherein the reciprocating gas compressor valve is ported plate valve.

5. A sealing element for use in a reciprocating gas compressor valve comprising a layer of elastomeric material bonded to a substrate.

6. The sealing element of claim 5 wherein the reciprocating gas compressor valve is a single element non-concentric valve.

7. The sealing element of claim 5 wherein the reciprocating gas compressor valve is concentric ring valve.

8. The sealing element of claim 5 wherein the reciprocating gas compressor valve is ported plate valve.

9. The sealing element of claim 1 wherein the elastomeric material is selected from the group consisting of natural rubber, synthetic rubber, fluoro-elastomer, thermoset elastomer, thermoplastic elastomer, elastomeric copolymers, elastomeric terpolymers, elastomeric polymer blends and elastomeric alloys.

10. The sealing element of claim 5 wherein the elastomeric material is selected from the group consisting of natural rubber, synthetic rubber, fluoro-elastomer, thermoset elastomer, thermoplastic elastomer, elastomeric copolymers, elastomeric terpolymers, elastomeric polymer blends and elastomeric alloys.

11. The sealing element of claim 1 wherein said elastomeric material operates between about −120° F. to 450° F.

12. The sealing element of claim 5 wherein said elastomeric material operates between about −120° F. to 450° F.

13. The sealing element of claim 1 wherein said elastomeric material operates between about 0 to 10,000 psid.

14. The sealing element of claim 5 wherein said elastomeric material operates between about 0 to 10,000 psid.

15. A reciprocating gas compressor valve comprising an elastomeric sealing element.

16. A reciprocating gas compressor valve comprising a sealing element having at least one layer of elastomeric material.

17. The reciprocating gas compressor valve of claim 15 wherein said valve is a single element non-concentric valve.

18. The reciprocating gas compressor valve of claim 15 wherein said valve is a concentric ring valve.

19. The reciprocating gas compressor valve of claim 15 wherein said valve is a ported plate valve.

20. The reciprocating gas compressor valve of claim 16 wherein said valve is a single element non-concentric valve.

21. The reciprocating gas compressor valve of claim 16 wherein said valve is a concentric ring valve.

22. The reciprocating gas compressor valve of claim 16 wherein said valve is a ported plate valve.

23. A reciprocating gas compressor comprising a reciprocating gas compressor valve having an elastomeric sealing element.

24. A reciprocating gas compressor comprising a reciprocating gas compressor valve having a sealing element, said sealing element having at least one layer made of elastomeric material.

25. A method of making a reciprocating gas compressor valve comprising the following steps:
applying elastomeric material to a substrate to produce an elastomeric sealing element; and
assembling said sealing element into a reciprocating gas compressor valve for use in a reciprocating gas compressor.

26. A method of making a reciprocating gas compressor valve comprising the following steps:
making a sealing element of elastomeric material; and
assembling said sealing element into a reciprocating gas compressor valve for use in a reciprocating gas compressor.
